(19) United States
(12) Patent Application Publication
(10) Pub. No.: US 2024/0057576 A1
(43) Pub. Date: Feb. 22, 2024

(54) Fishing Lure

(71) Applicants: Scott Henderson, Costa Mesa, CA (US); Daniel Maiman, Aliso Viejo, CA (US)

(72) Inventors: Scott Henderson, Costa Mesa, CA (US); Daniel Maiman, Aliso Viejo, CA (US)

(21) Appl. No.: 18/340,828

(22) Filed: Jun. 23, 2023

Related U.S. Application Data
(63) Continuation-in-part of application No. 17/126,723, filed on Dec. 18, 2020.

(51) Int. Cl. A01K 85/00

(52) U.S. Cl. CPC A01K 85/029; A01K 85/005

(57) ABSTRACT

A fishing lure that includes magnetizable, exchangeable plates on the dorsal and ventral surface of the lure. A magnet is provided within the lure body for releasable attraction of various plates to the top and bottom surface of the lure. The elongate body allows for placement of different plates within the single elongate body, thus changing the look of the lure.

### CROSS-REFERENCE TO RELATED APPLICATIONS

This application claims priority to patent application Ser. No. 17/126,723, entitled “Fishing Lure”, and filed Dec. 18, 2020, the entirety of which is incorporated by reference.

### TECHNICAL FIELD

The inventions described below relate to the field of fishing lures with releasable plates that can be changed to vary the look of the lure.

### BACKGROUND

A fishing lure is a type of artificial fishing bait that is intended to attract a fish's attention. Fish are naturally attracted to the live bait, but the lure is a substitute used by fisherman to catch fish. The fisherman controls and manipulates movement of the lure to attract the fish. The fishing lure is tied to the fishing line, which is connected to a fishing reel and rod. Fishermen reel in the fishing line, sweep the fishing rod, or let out line to manipulate the motion of the lure. The desire to effectively attract fish requires use of multiple different types of lures. This results in the constant replacing of the lures depending on the fishing conditions. Consequently, there is a need for a single lure body that can cheaply and easily provide removable and replaceable plates for different looks in order to more effectively attract fish.

### SUMMARY

The devices and methods described below provide for a fishing lure that contains removable and replaceable plates. A single body includes a magnet within the lure body for releasable attraction of various plates to the top and bottom surface of the lure. The elongate body allows for placement of different plates within the single elongate body, thus changing the look of the lure. Each plate is shaped to fit within a beveled recess with the top and bottom surfaces of the lure body of each surface within the elongate body. The plates may be any color or include various ornamental or functional indicia on the plate to allow a user to select from a variety of plate styles for interchangeable use with the single housing. A single lure base can achieve multiple different looks merely by placing different plates sets which is economical for the user.

### BRIEF DESCRIPTION OF THE DRAWINGS

FIG. 1 illustrates a fishing lure with releasable plates.

FIG. 2 is an exploded sectional view of the fishing lure with the releasable plates and its component parts.

FIG. 3 is a view of the fishing lure without the plates or rings shown in FIGS. 1 and 2.

FIG. 4 is a top view of the fishing lure of FIG. 1.

FIG. 5 is a sectional view of a fishing lure according to another embodiment.

FIG. 6 is a perspective view of the fishing lure of FIG. 5.

### DETAILED DESCRIPTION

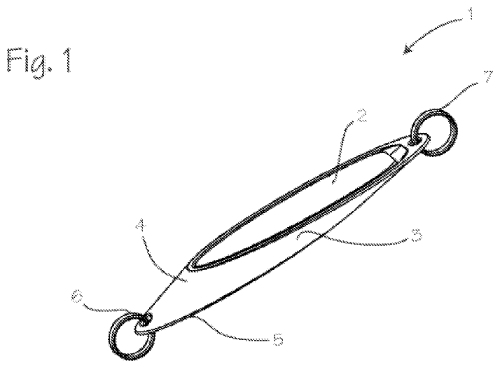

FIG. 1 illustrates a fishing lure 1 with one or more releasable plates 2. The fishing lure includes an elongate body 3 that is roughly fish-shaped with a corresponding analogous dorsal surface 4 and ventral surface 5. The elongate body also includes a first end having a ring 6 adapted to be attached to a fishing line and a second end having a second ring 7 adapted to be attached to at least one hook (not shown). The dorsal surface and ventral surface each house a releasable plate.

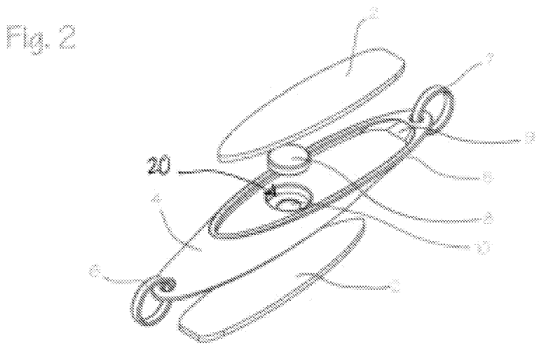

FIG. 2 is exploded sectional view of the fishing lure and its component parts. The figure illustrates the various parts of the fishing lure and includes a magnet 8 within the lure elongate body. The elongate body 3 includes a dorsal top surface 4 and a ventral surface 5. Both the dorsal surface and ventral surface have a recess 9 within the surface. The recess may be beveled. The recess has a more pronounced slant at one end of the recess and tapers to a smaller slant at the opposite end. The recess must be deeper than the plate thickness, at least at one end, so that the depression of the plate into the recess results in lifting of the opposite end of the plate. The elongate body may include a recess or through hole 10 configured to house a magnet therein. The magnet may be contained within the recess for magnetic connection of each plate within the dorsal surface and ventral surface. Alternatively, the dorsal surface and the ventral surface may include a magnetic surface to magnetically attract the plates. The elongate body allows for placement of different plates within the single elongate body, thus changing the look of the lure. Each plate is shaped to fit within the recess of each surface within the elongate body. The plates may be any color or include various ornamental or functional indicia on the plate to allow a user to select from a variety of plate styles for use within a single housing. This allows the aesthetic or functional look of the lure to be changed according to fishing conditions or user requirements. The elongate body also has a first end and a second end. The first end contains a first ring 6 for connecting at least one hook and the second end contains a second ring 7 to attach the lure to a fishing line.

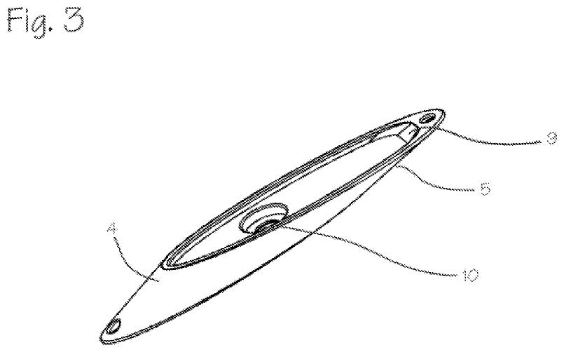

FIG. 3 illustrates the elongate body without the plates or rings. The dorsal surface 4 and ventral surface 5 include a recess 9 within each surface. The recess is more pronounced at one end and tapers to a lesser slant at the opposite end and is deeper than the plate thickness, at least at one end. The elongate body may further include a hole 10 that extends from the dorsal surface through the ventral surface to house a magnet. The recessed surface allows for user to place interchangeable plates within the recesses on the dorsal surface and the ventral surface and remove the plates without the assistance of a tool. Moreover, the plates can be interchanged without retying or removing the lure body from the line, and instead plates may be changed with the lure in position. The plates are made of any material that securely, but releasably, attracts to a magnet. In addition, replacement of only the lure plates with a single elongate body provides economical savings to the user.

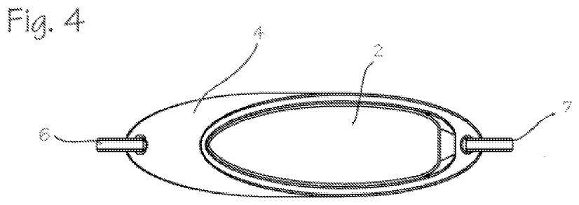

FIG. 4 is a top view of the fishing lure of FIG. 1. The figure illustrates what the dorsal plate look like within the dorsal surface of the elongate body. The dorsal plate is inserted within a beveled recess in the dorsal surface. The plate can include be any color and can include visual or functional indicia that may be attractive to fish.

In use, a user positions a first plate within the dorsal surface and a second plate within the ventral surface of the housing in order to engage the plates with the magnet, or magnetic surface, to be releasably secured within the body. The plates are secure enough to remain within the body while the lure is in the water. However, the plates are easily changed for other colored plates or plates with other preferred visual indicia. The varied slant of the beveled recess allows for placement of each plate into the dorsal or ventral surface for strong magnetic connection to the magnet but also allows for ease of removal of the plate from the elongate body. Specifically, a user can remove the plate merely by insertion of a finger at the end of the beveled recess. A user can easily remove and replace the plates within the recess without the use of any tool. The recess allows easier release of the plate while still maintaining proper attraction between the plates and the magnet. When the desired plates are placed on the dorsal and ventral surfaces, the fishing lure is attached at one end to at least one hook and at the opposite end to the fishing line. Advantageously, the plates can be interchanged without re-tying or removing the lure body from the line. The lure is used to attract fish by reflecting light and moving randomly through the water. The lure is moved by winding the line back to the reel and is adjusted by the user to catch fish.

As described above, the magnet housing 20 may include a through hole 10 to accommodate a removable magnet. The through hole 10, or magnet seating, may have a larger opening on one side to accept the magnet, and a retaining plate including the through hole on the other side to retain the magnet in the recess, but also allow access through the through hole 10 to remove the magnet. Alternatively, the magnet may be secured in the recess via, e.g., an adhesive, press fit, weld, etc.

In an embodiment, the plates are interchangeable. Pairs of plates having similar color, patterns, and/or textures may be attached to the dorsal and ventral sides of the lure. Another feature is, as the plates are exchangeable and secured, at least in part, due to a magnetic attachment to a magnetic material in the lure, the magnetic attraction or force should be sufficient to secure the plates while the lure is in the water and may experience turbulence or forces due to the fish on the hook, but not too strong as to make it difficult for a user to “quick-release” the plates to exchange them.

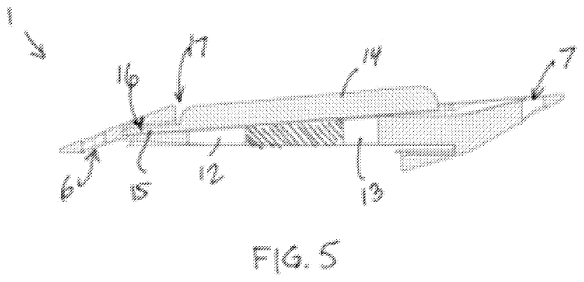

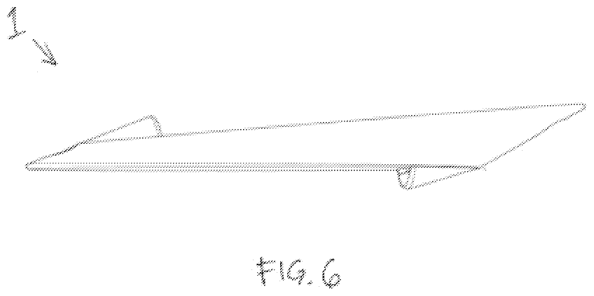

In another embodiment, the lure 1 may include multiple magnets to secure the plates. In the embodiment shown in FIGS. 5 and 6, the lure includes a first magnet housing 11 and a second magnet housing 12. This design may enable the use of less strong magnets as the associated plate is being magnetically attached at multiple points on the plate and over a larger surface area than with the use of a single magnet.

Although only one plate 13 is shown in FIG. 5, another plate may also be inserted on the dorsal side of the lure 1. The plates may have identical sizes, colors, and shapes.

With regard to the quick-release aspect of the lure plates, as described above, the recess must be deeper than the plate thickness, at least at one end, so that the depression of the plate into the recess results in lifting of the opposite end of the plate. For example, the user and depress one end of the plate with a finger or thumb and release the magnetic attraction.

The plate 13 shown in FIG. 4 may include a tab 15 which fits in an associated slot 16 in the lure. In this configuration, the user may use a finger or thumb at a junction 17, or bump, to slide the plate out when exchanging plates.

While the preferred embodiments of the devices and methods have been described in reference to the environment in which they were developed, they are merely illustrative of the principles of the inventions. The elements of the various embodiments may be incorporated into each of the other species to obtain the benefits of those elements in combination with such other species, and the various beneficial features may be employed in embodiments alone or in combination with each other. Other embodiments and configurations may be devised without departing from the spirit of the inventions and the scope of the appended claims.

The foregoing method descriptions and figures are provided as illustrative examples only. The order of operations in the aspects described herein may be performed in any order. Words such as “thereafter,” “then,” “next,” etc. are used to guide the reader through the description of the methods and systems described herein, and do not limit the order of the operations. Any reference to claim elements in the singular, for example, using the articles “a,” “an,” or “the” is not to be construed as limiting the element to the singular. Also, relative terms such as “top,” “bottom,” “upper,” “lower,” “above,” “below,” and the like as used herein describe the relative positions of elements or features, and are not limited to the orientations depicted in the drawings. Furthermore, the specific dimensions and other details set forth with regard to specific embodiments are for illustrative purposes only and are not intended to limit the scope of the claims.

The preceding description of the disclosed aspects is provided to enable any person skilled in the art to make, implement, or use the claims. Various modifications to these aspects will be readily apparent to those skilled in the art, and the generic principles defined herein may be applied to other aspects without departing from the scope of the claims. Thus, the present disclosure is not intended to be limited to the specific embodiments described herein but is to be accorded the widest scope consistent with the claims.

1. A fishing lure comprising:
an elongate body including
a dorsal surface having an area and including a first recess having a flat planar inner surface, the first recess having an area greater than 50% of the area of the dorsal surface and include a first end and a second end,
a ventral surface having an area and including a second recess having a flat planar inner surface, the second recess having an area greater than 50% of the area of the ventral surface, and
a magnet recess extending between a first recess inner surface and a second recess inner surface and having an opening located in the first recess inner surface,
a magnet shaped to fit in the magnet recess such that no portion of the magnet extends beyond the opening in the first recess inner surface;
a first plate having a flat planar bottom surface configured to form a releasable magnetic attachment to at least a portion the first recess inner surface via the magnet and a shape corresponding to the shape of the first recess, wherein the recess has a more pronounced slant at the first end of the recess and tapers to a smaller slant at the second end to provide a deeper portion to enable a user to press the first plate at a position corresponding to said deeper portion and facilitate releasing said magnetic attachment between the first plate and the magnet; and
a second plate configured to form a releasable magnetic attachment to the second recess inner surface via the magnet and a shape corresponding to the shape of the second recess, wherein the first recess inner surface and the second recess inner surface are parallel.

2. The fishing lure of claim 1, wherein the elongate body includes a first end and a second end, and further comprising a first ring at the first end of the elongate body.

3. The fishing lure of claim 2 further comprising a second ring at the second end of the elongate body.

4. The fishing lure of claim 1 wherein the first and second plates each include a top surface having a first color.

5. The fishing lure of claim 1 wherein the dorsal recess is beveled.

6. The fishing lure of claim 1 wherein the ventral recess is beveled.

7. The fishing lure of claim 4, further comprising:
a first replacement plate having a flat planar bottom surface configured to be releasably attached to the first recess inner surface via the magnet; and
a second replacement plate configured to be releasably attached to the second recess inner surface via the magnet, wherein the first replacement plate and the second replacement second plate each include a top surface having a second color different than the first color.

8. The fishing lure of claim 1, wherein each of the first plate and the second plate include a smooth top surface.

9. The fishing lure of claim 1, further comprising another magnet recess.
